(19) United States
(12) Patent Application Publication
(10) Pub. No.: US 2026/0290344 A1
(43) Pub. Date: Sep. 24, 2026

(54) INFORMATION PROCESSING DEVICE, INFORMATION PROCESSING METHOD, AND PROGRAM

(71) Applicant: LIVING ROBOT INC., Date-shi, Fukushima (JP)

(72) Inventors: Yasuhiro KAWAUCHI, Date-shi, Fukushima (JP); Akihiko UCHIYAMA, Date-shi, Fukushima (JP); Takahiro INOUE, Date-shi, Fukushima (JP); Tamaki NAKAMURA, Date-shi, Fukushima (JP); Fumiko KONDOU, Date-shi, Fukushima (JP); Mayu SUZUKI, Date-shi, Fukushima (JP); Koji TOKUNAGA, Date-shi, Fukushima (JP)

(21) Appl. No.: 19/476,306

(22) PCT Filed: Apr. 17, 2024
(86) PCT No.: PCT/JP2024/015295

§ 371 Date: Oct. 17, 2025

(30) Foreign Application Priority Data
Apr. 18, 2023 (JP) 2023-068120

(51) Int. Cl. G10L 15/22

(52) U.S. Cl. CPC G10L 15/222

(57) ABSTRACT

A cloud server includes an interface control unit, an device operation setting information acquisition unit, and a conflict information notification unit. The interface control unit controls an interface including an interaction between the user and the monitoring robot. The device operation setting information acquisition unit acquires device operation setting information of each of the plurality of devices, which are connectable via a network When information indicating that a prescribed function will be executed has been acquired from a prescribed device among the plurality of devices, and it has been determined, by referring to the device operation setting information and in response to the fact that the information has been acquired, that execution of the prescribed function will conflict with the operation settings for the other devices, the conflict information notification unit notifies the user accordingly via a dialog on the basis of control of the interface control unit.

### TECHNICAL FIELD

The present invention relates to an information processing apparatus, an information processing method, and a program.

### BACKGROUND ART

Conventionally, dialogue systems exist that switch a dialogue mode in order to avoid misrecognition due to surrounding noise, and to smoothly complete a multi-round dialogue task currently in progress (for example, see Patent Document 1).

### CITATION LIST

### Patent Documents

Patent Document 1: Japanese Unexamined Patent Application (Translation of PCT Application), Publication No. 2022-554219

### DISCLOSURE OF THE INVENTION

### Problems to be Solved by the Invention

However, Patent Document 1 does not propose a dialogue mechanism that, in communication with a plurality of devices and during execution of functions that affect one another, notifies to that effect.

In view of such circumstances, an object of the present invention is to enable a user, merely by engaging in dialogue, to know when a plurality of devices execute functions that affect one another.

### Means for Solving the Problems

In order to achieve the above object, an information processing apparatus according to one embodiment of the present invention includes:
an interface control unit configured to control an interface including dialogue with a predetermined user;
a device operation setting information acquisition unit configured to acquire respective device operation setting information of a plurality of devices connectable via a communication network; and
an influence information notification unit configured to, in response to acquisition of information indicating execution of a predetermined function from a predetermined device among the plurality of devices, refer to the device operation setting information and, when execution of the predetermined function is determined to affect an operation setting of another device, to notify a user to that effect by the dialogue or by interrupting the dialogue under control of the interface control unit. An information processing method and a program corresponding to the above-described information processing apparatus are also provided as one aspect of the present invention.

### Effects of the Invention

According to the present invention, merely by engaging in dialogue, a user can know when a plurality of devices execute functions that affect one another.

### BRIEF DESCRIPTION OF THE DRAWINGS

FIG. 1 illustrates an overall network configuration of an information processing system according to one embodiment of the present invention;

FIG. 2 is a block diagram illustrating a hardware configuration of a cloud server in the information processing system illustrated in FIG. 1;

FIG. 3 is a block diagram illustrating a hardware configuration of a monitoring robot in the information processing system illustrated in FIG. 1;

FIG. 4 is a functional block diagram illustrating a functional configuration of the cloud server in the information processing system illustrated in FIG. 1;

FIG. 5 is a flowchart illustrating operations of the cloud server illustrated in FIG. 3 and FIG. 4;

FIG. 6 is a diagram illustrating a first embodiment of a Living Robot Care service in the information processing system illustrated in FIG. 1;

FIG. 7 is a diagram illustrating a second embodiment of the Living Robot Care service in the information processing system illustrated in FIG. 1;

FIG. 8 is a diagram illustrating a third embodiment of the Living Robot Care service in the information processing system illustrated in FIG. 1;

FIG. 9 is a diagram illustrating a fourth embodiment of the Living Robot Care service in the information processing system illustrated in FIG. 1;

FIG. 10 is a diagram illustrating a fifth embodiment of the Living Robot Care service in the information processing system illustrated in FIG. 1;

FIG. 11 is a diagram illustrating a first example of a sixth embodiment of the Living Robot Care service in the information processing system illustrated in FIG. 1;

FIG. 12 is a functional block diagram illustrating a second functional configuration of the cloud server illustrated in FIG. 4;

FIG. 13 is a diagram illustrating a seventh embodiment of the Living Robot Care service in an information processing system including a cloud server having the second functional configuration illustrated in FIG. 12;

FIG. 14 is a diagram illustrating an eighth embodiment of the Living Robot Care service in an information processing system including a cloud server having the second functional configuration illustrated in FIG. 12;

FIG. 15 is a diagram illustrating a ninth embodiment of the Living Robot Care service in an information processing system including a cloud server having the second functional configuration illustrated in FIG. 12;

FIG. 16 is a diagram illustrating a tenth embodiment of the Living Robot Care service in an information processing system including a cloud server having the second functional configuration illustrated in FIG. 12;

FIG. 17 is a diagram illustrating an eleventh embodiment of the Living Robot Care service in an information processing system including a cloud server having the second functional configuration illustrated in FIG. 12; and

FIG. 18 is a diagram illustrating a twelfth embodiment of the Living Robot Care service in an information processing system including a cloud server having the second functional configuration illustrated in FIG. 12.

### PREFERRED MODE FOR CARRYING OUT THE INVENTION

Hereinafter, embodiments of the present invention will be described with reference to the drawings.

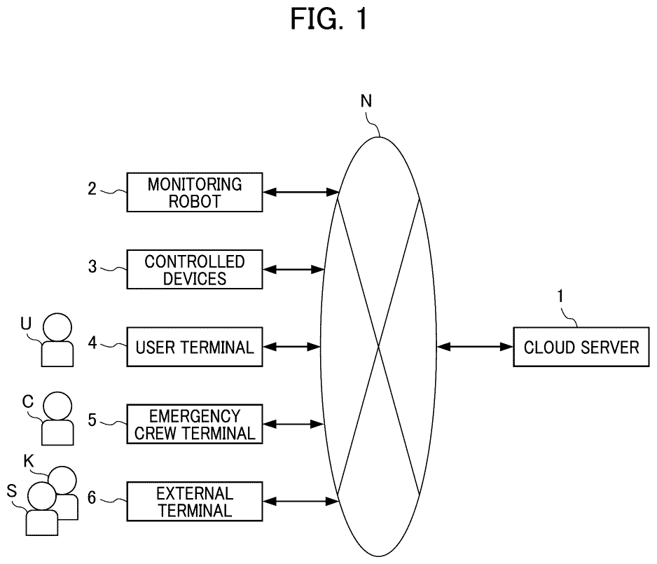

FIG. 1 illustrates an overall configuration of an information processing system according to one embodiment of the present invention. The information processing system illustrated in FIG. 1 is configured to enable communication by interconnecting a cloud server 1, a monitoring robot 2 (serving as an interface), controlled devices 3, a user terminal 4, an emergency crew terminal 5, and an external terminal 6 via a predetermined network N such as the Internet.

The cloud server 1 is an information processing apparatus that executes various types of processing in order to manage respective operations of interfaces such as the monitoring robot 2, the controlled devices 3, the user terminal 4, the emergency crew terminal 5, and the external terminal 6.

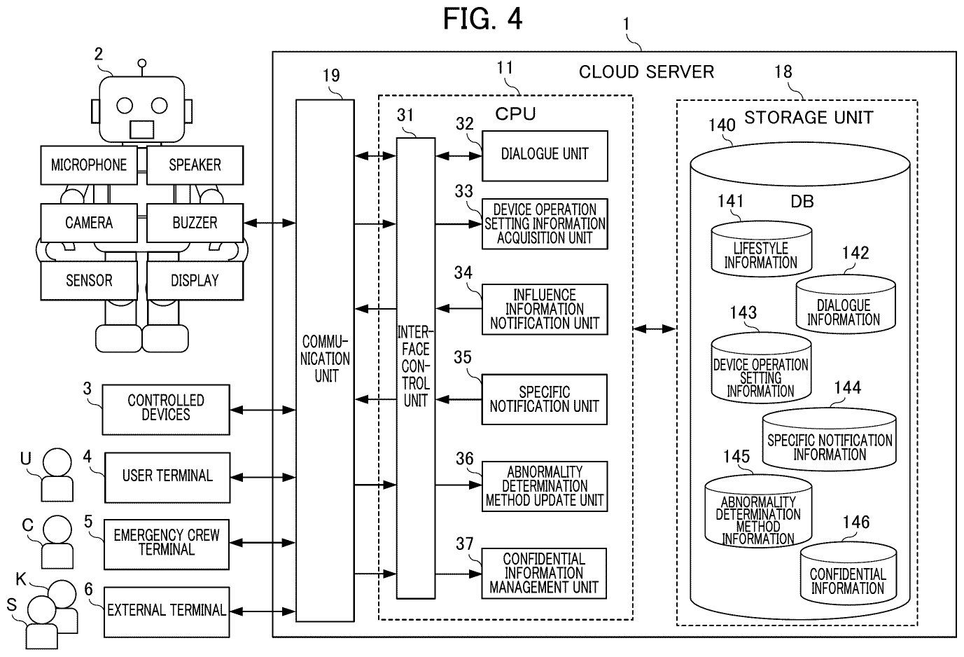

Specifically, in the present embodiment, the cloud server 1 manages respective operations of the monitoring robot 2 and the user terminal 4 as follows. That is, the cloud server 1 is managed by a service provider such as a service operating company providing the present service, and is operated by staff responsible therefor. The cloud server 1 manages various kinds of information obtained when the monitoring robot 2 operates the controlled devices 3 during a conversation between a user U and the monitoring robot 2 (including lifestyle information, dialogue information, device operation information, specific notification information, secret information, abnormality determination method information, and detection information from respective sensors), and executes processing based on the respective information. Details of the processing executed by the cloud server 1 will be described later with reference to FIG. 4. The controlled devices 3 are some of the devices installed in the home of the user U, for example, a television, a video recorder, an air conditioner, a refrigerator, a washing machine, a bathroom dryer, an electric pot, and the like, and are devices controlled by control signals from the monitoring robot 2 or the cloud server 1. In addition, the controlled devices 3 also include various sensors that perform self-detection and transmit detection signals to the monitoring robot 2 or the cloud server 1, such as a bathroom fall sensor, an odor sensor, a fire alarm, an environmental monitoring sensor, an excretion sensor, a sleep vitals and wake-up sensor, and a surveillance camera. The user terminal 4 is an information processing apparatus managed and operated by a user U such as an elderly user, and is managed on a per-user basis. The user terminal 4 is a portable terminal, such as a smartphone (hereinafter, “smartphone”), a tablet terminal, or a laptop computer, which allows the user U to carry the terminal and to view and input information. In addition, the user terminal 4 also includes a remote controller (hereinafter, “remote controller”) capable of operating household appliances such as a television (hereinafter, “television”), a video recorder, and lighting equipment. The emergency crew terminal 5 is, for example, an information processing apparatus for emergency reporting handling installed in a fire station, or a device operated by paramedics dispatched from the fire station, such as a personal computer (PC), a tablet terminal, or a smartphone. The external terminal 6 is an information processing apparatus managed by, for example, a child or grandchild of an elderly user U, a staff member of a service provider S (service operating company) that provides a monitoring service, or a delivery staff member, and is, for example, a personal computer (PC), a tablet terminal, or a smartphone.

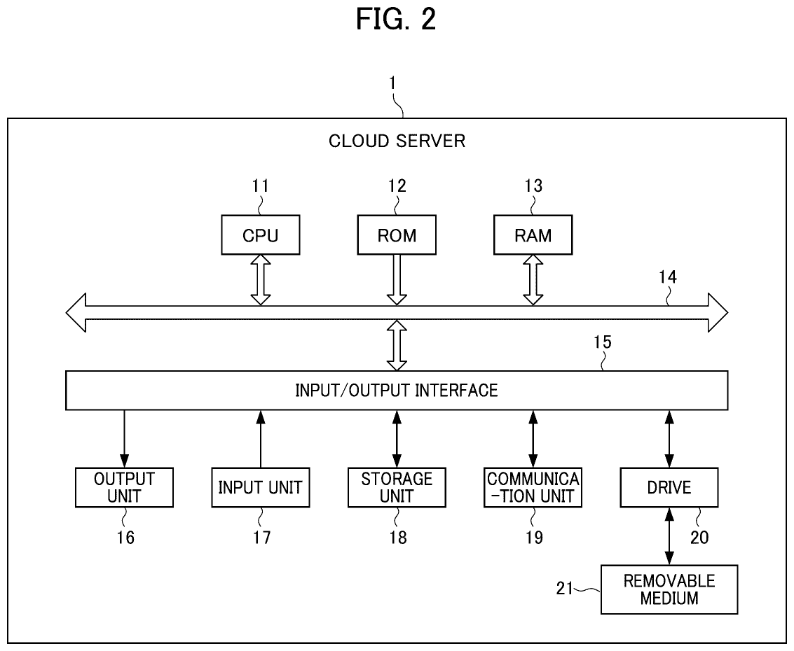

FIG. 2 is a block diagram illustrating a hardware configuration of the cloud server in the information processing system illustrated in FIG. 1.

As illustrated in FIG. 2, the cloud server 1 includes a CPU (Central Processing Unit) 11, ROM (Read-Only Memory) 12, RAM (Random-Access Memory) 13, a bus 14, an input/output interface 15, an output unit 16, an input unit 17, a storage unit 18, a communication unit 19, and a drive 20.

The CPU 11 executes various types of processing in accordance with a program recorded in the ROM 12, or a program loaded into the RAM 13 from the storage unit 18. Data necessary for the CPU 11 to execute various types of processing is also stored, as appropriate, in the RAM 13.

The CPU 11, the ROM 12, and the RAM 13 are mutually connected via the bus 14. The input/output interface 15 is also connected to the bus 14. The output unit 16, the input unit 17, the storage unit 18, the communication unit 19, and the drive 20 are connected to the input/output interface 15.

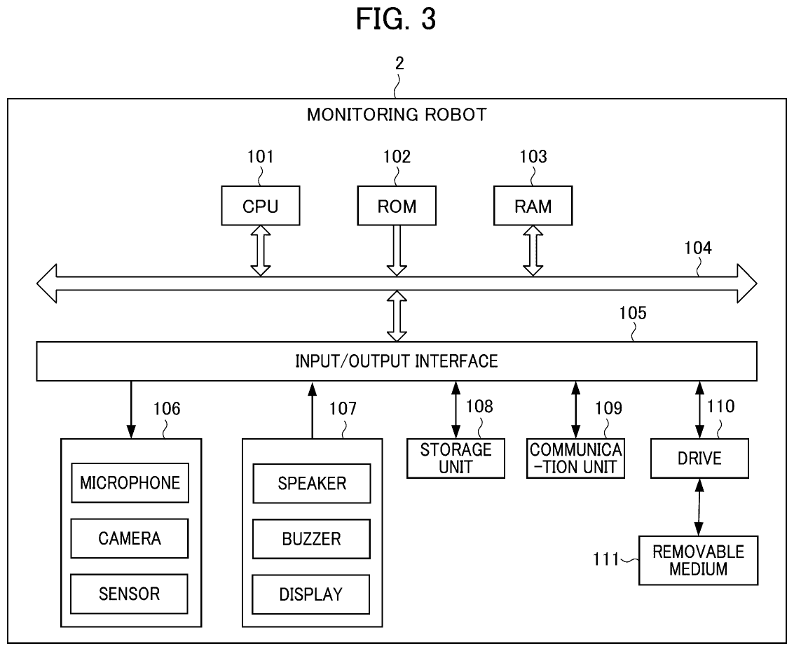

The output unit 16 is configured by a display such as an LCD (Liquid Crystal Display), a speaker, or the like, and outputs various information as images or audio. The input unit 17 is configured by, for example, a keyboard, and outputs various information. The storage unit 18 is configured by, for example, a DRAM (Dynamic Random Access Memory), and stores various data. The communication unit 19 communicates with other devices (for example, the monitoring robot 2 illustrated in FIG. 3 and the external terminal 6) via the network N including the Internet.

A removable medium 21, formed of a magnetic disk, an optical disk, a magneto-optical disk, semiconductor memory, or the like, is appropriately mounted in the drive 20. A program read from the removable medium 21 by the drive 20 is installed in the storage unit 18 as required. The removable medium 21 can store various data stored in the storage unit 18, in the same manner as the storage unit 18.

Although not illustrated, the user terminal 4, the emergency crew terminal 5, and the external terminal 6 also have hardware configurations substantially the same as the hardware configuration of the cloud server 1 illustrated in FIG. 4. Accordingly, descriptions of the hardware configurations of the user terminal 4, the emergency crew terminal 5, and the external terminal 6 (for example, a terminal of a family member of the user U, or a terminal of the service provider S) are omitted.

Through cooperation between the various items of hardware illustrated in FIG. 2 and various software, it becomes possible to execute a series of processing related to dialogue between the user U and the monitoring robot 2.

FIG. 3 is a block diagram illustrating a hardware configuration of the monitoring robot in the information processing system illustrated in FIG. 1. As illustrated in FIG. 3, the monitoring robot 2 includes a CPU (Central Processing Unit) 101, ROM (Read-Only Memory) 102, RAM (Random-Access Memory) 103, a bus 104, an input/output interface 105, an output unit 106, an input unit 107, a storage unit 108, a communication unit 109, and a drive 110. The hardware configuration of the monitoring robot 2 is substantially the same as the hardware configuration of the cloud server 1, except for differences in the configurations of the output unit 106 and the input unit 107. The monitoring robot 2 adopts a body resembling a human shape in order to make dialogue with the user U natural. Accordingly, a microphone of the output unit 106 is disposed at a position corresponding to an ear, a camera of the input unit 107 is disposed at a position corresponding to an eye, sensors are disposed in limbs, a speaker and a buzzer of the output unit 106 are disposed at a position corresponding to a mouth, and a display is disposed, for example, on a front portion of the body.

FIG. 4 is a functional block diagram illustrating a functional configuration of the cloud server in the information processing system illustrated in FIG. 1.

A DB 140 containing lifestyle information 141, dialogue information 142, device operation setting information 143, specific notification information 144, abnormality determination method information 145, and secret information 146 is stored in one region of the storage unit 18 (FIG. 2) of the cloud server 1. The lifestyle information 141 includes, for example, scheduled wake-up time/actual wake-up time, scheduled mealtime/actual mealtime (meal start time/meal end time), meal content (menu, calories or the like), scheduled activities/activity records, scheduled bedtime/actual bedtime, and scheduled bathing time (in/out)/actual bathing time (in/out), or the like. The dialogue information 142 includes audio data, text data, or the like of conversation content of both parties, in which the monitoring robot 2 responds to enquiries from the user U. In a case where no limitation exists in storage capacity, videos and images including behavior of the user U, captured by the monitoring robot 2 during dialogue with the user U, may also be included in the dialogue information 142. The device operation setting information 143 includes, for example, detection settings and sensitivity settings of a bathroom fall sensor, sensitivity settings of an odor sensor, detection settings and sensitivity settings of a fire alarm, operation settings of a television, recording settings of a video recorder, operation and temperature settings of an air conditioner, operation and temperature settings of a refrigerator, operation settings of a washing machine, operation settings of a bathroom dryer, and operation settings of an electric pot. The specific notification information 144 is notification information from a specific device, and includes, for example, information such as a contact and a message for reporting to a fire department in a case where a bathroom fall sensor detects the fall of a person in a bathroom. The abnormality determination method information 145 is information on determination processing and procedures for a device such as a bathroom fall sensor to determine an abnormality and make a specific notification. The secret information 146 is information stored based on a specific management attribute designated by the user U, and is information not disclosed to others when the user U and the monitoring robot 2 have a secret conversation, for example, in a case where the specific management attribute corresponds to a secret conversation. Specifically, for example, soliloquies of the user U, a diary, and emotions at that time are stored in the DB 140 as information that is not output or accessible to any person other than the user U, and cannot be deleted even by the user U.

As illustrated in FIG. 4, in the CPU 11 (FIG. 2) of the cloud server 1, when a series of processing related to the Living Robot Care service for the user U is executed, an interface control unit 31, a dialogue unit 32, a device operation setting information acquisition unit 33, an influence information notification unit 34, a specific notification unit 35, and an abnormality determination method update unit 36 function.

The interface control unit 31 controls an interface including dialogue with the user U. For example, the interface control unit 31 regards an elderly person living at home, a person requiring care, or a person with a disability as the user U (a predetermined user), and controls the interface including dialogue between the user U and the monitoring robot 2.

Specifically, the interface control unit 31 executes control of an output for confirming with the user U, among a plurality of devices present in the home, in a case where a specific device such as a bathroom fall sensor attempts to make a notification to a fire department. Specifically, when a bathroom fall sensor is about to report a bathroom fall to the fire department, the interface control unit 31 can cause the monitoring robot 2 to output an audio message to confirm with the user U whether reporting to the fire department is appropriate, since the bathroom fall sensor has detected a fall but there is a possibility of erroneous operation due to noise from the bathroom dryer.

The interface control unit 31 acquires lifestyle information of the user U based on dialogue with the user U, and the specific notification unit 35 executes abnormality determination based on the lifestyle information. Accordingly, merely by engaging in dialogue, the user U can have the lifestyle information of the user U managed, for example, with respect to a daily bathing time of the user U, whereby notification accuracy for specific notifications can be improved. The management of lifestyle information includes management of execution records for “schedule management (verbal prompting)”, “music therapy”, and “brain games”. By managing the lifestyle information of the user U in this manner, for example, in a case where the bathroom fall sensor detects a fall at a time that is not a bathing time of the user U, and the bathroom dryer is operating, the detection can be determined as a false detection due to noise of the bathroom dryer, a false report in such a case can be prevented, and notification accuracy can be improved.

In a case where dialogue is conducted via the monitoring robot 2 between the user U and another user having a specific relationship with the user U, for example, a child or grandchild of an elderly user U, a staff member of the service provider S (service operating company) that provides a monitoring service, or a delivery staff member, the interface control unit 31 performs predetermined input/output processing (for example, automatically starting the eye camera of the monitoring robot 2, capturing an elderly user U who is a conversation target, and distributing the captured image to an external terminal 6 of the child or grandchild). Additionally, the monitoring robot 2 may output an audio message to inform the user U of events that have occurred since a previous monitoring visit. Accordingly, the convenience of dialogue between the elderly user U and a child or grandchild can be improved, conversation topics can be provided, and a positive mental state of the user U can be fostered.

The dialogue unit 32 engages in dialogue with the user U via the monitoring robot 2.

Words for dialogue may be realized by reasoning processing by AI or the like. Phrases such as answers to predetermined questions may be registered in the DB 140 as the dialogue information 142, and appropriate words may be read from the dialogue information 142 during dialogue with the user U.

The device operation setting information acquisition unit 33 acquires the device operation setting information 143 of each of the plurality of devices, such as a bathroom fall sensor, an odor sensor, a fire alarm, a television, a video recorder, an air conditioner, a refrigerator, a washing machine, a bathroom dryer, and an electric pot, which are connectable via a communication network such as the network N. The device operation setting information 143 includes, for example, detection settings and sensitivity settings of the bathroom fall sensor, sensitivity settings of the odor sensor, detection settings and sensitivity settings of the fire alarm, operation settings of the television, recording settings of the video recorder, operation and temperature settings of the air conditioner, operation and temperature settings of the refrigerator, operation settings of the washing machine, operation settings of the bathroom dryer, and operation settings of the electric pot.

Upon acquiring from a predetermined device such as a bathroom fall sensor among the plurality of devices, information indicating that emergency reporting will be executed, the influence information notification unit 34 refers to the device operation setting information 143. When execution of the predetermined function is determined to affect an operation setting of another device, the influence information notification unit 34, under control of the interface control unit 31, notifies to that effect, by dialogue or by interrupting the dialogue, a party such as the user U, another family member K, or the service provider S.

As a specific example, when the influence information notification unit 34 determines that operation of a bathroom dryer causes erroneous operation of a bathroom fall sensor, a message indicating a possibility that operation of the bathroom dryer is causing erroneous operation of the bathroom fall sensor is transmitted to the monitoring robot 2. The monitoring robot 2 then issues an audio message to notify the user U.

As a method for notifying a message, in addition to the monitoring robot 2 outputting an audio message, the user terminal 4 may display a pop-up message. Accordingly, merely by engaging in dialogue with the monitoring robot 2, or by operating and viewing the user terminal 4, the user U can know that, for example, there is a possibility of erroneous operation when the bathroom dryer, the bathroom fall sensor, or the emergency reporting function executes functions that affect one another.

The device operation setting information acquisition unit 33 acquires the device operation setting information 143, based on dialogue with the user U conducted under control of the interface control unit 31. Accordingly, merely by engaging in dialogue with the monitoring robot 2, the user U can set operation settings of devices installed at home. For example, during dialogue between the user U and the monitoring robot 2, in a case where the user U says “It's a little hot”, the device operation setting information acquisition unit 33 acquires operation settings of an air conditioner, transmits the operation settings to the interface control unit 31, and the interface control unit 31 adjusts the settings, such as increasing the set temperature included in the operation settings of the air conditioner by one degree.

The influence information notification unit 34, based on dialogue with the user U conducted under control of the interface control unit 31, notifies to that effect, namely an influence of functions occurring between devices (for example, a possibility of erroneous operation). Specifically, during dialogue between the user U and the monitoring robot 2, in a case where the user U says something such as “The bathroom dryer is running”, and the bathroom fall sensor detects a fall despite the user U not being in the bathroom while the bathroom dryer is operating, the influence information notification unit 34 determines that there is a possibility that noise of the bathroom dryer causes erroneous operation of the bathroom fall sensor, and notifies the user U to that effect, namely that the noise of the bathroom dryer affects the fall-detection function of the bathroom fall sensor (for example, a possibility of erroneous operation). Accordingly, merely by engaging in dialogue with the monitoring robot 2, the user U can know, for example, that execution of the drying function of the bathroom dryer may affect operation of fall detection by the bathroom fall sensor, or operation of emergency reporting.

In a case where abnormality determination is made based on the device operation setting information 143 of a plurality of devices, the specific notification unit 35, under control of the interface control unit 31, makes a specific notification such as emergency reporting to a fire department. Here, abnormality determination refers to determining, when a bathroom fall sensor (a specific device) detects a fall, whether the detection information of the bathroom fall sensor is abnormal, with reference also to operation information of devices other than the bathroom fall sensor, such as a bathroom dryer, and to the user U's spoken statements (for example, “I'm okay” or “Help!”). Accordingly, accuracy of a specific notification (for example, emergency reporting triggered by fall detection by the bathroom fall sensor) can be improved, based on the device operation setting information 143 of the plurality of devices.

Under control of the interface control unit 31, the specific notification unit 35 further outputs information relating to the abnormality determination (for example, the location of the bathroom in which the user U has fallen) to a responder who responds to the emergency reporting (specific notification), for example, a paramedic C dispatched from a fire station. Specifically, when the paramedic C who has arrived at the site makes a spoken statement such as “Emergency crew here” to the monitoring robot 2, the interface control unit 31 identifies the paramedic C, and causes the monitoring robot 2 to issue an audio message such as “Collapsed in the bathroom on the right at the far end of the corridor!”. Accordingly, for example, the paramedic C of the emergency crew that has arrived at the site can be informed of where the user U has fallen.

With respect to a determination result of abnormality determination, the abnormality determination method update unit 36, under control of the interface control unit 31 and based on the acquired information on the necessity of the specific notification, updates the determination logic of abnormality determination or determination method (abnormality determination method) used by the specific notification unit 35. Accordingly, for example, in a case where a device is determined to be abnormal and a specific notification is about to be issued, and dialogue with the user U indicates that the specific notification is unnecessary, the subsequent abnormality determination method can be revised.

Under control of the interface control unit 31, a confidential information management unit 37 manages the secret conversation based on the specific management attribute, in response to acquisition by the cloud server 1, via the monitoring robot 2, of information on a secret conversation designated by the user U, namely a secret conversation to be shared only between the user U and the monitoring robot 2 (specific management attribute). As secret conversation information, for example, soliloquies of the user U, a diary, and emotions at that time are stored in a storage medium such as non-volatile memory as information that is not output to any person other than the user U, is not accessible by any person other than the user U, and is not deletable even by the user U. Accordingly, through the exchange of secret information confessed only to the monitoring robot 2 by the user U, emotional attachment to the monitoring robot 2 can be fostered.

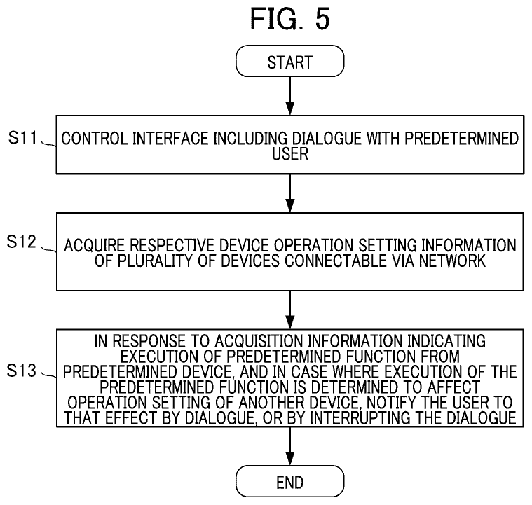

Next, operations of the cloud server in the information processing system will be described with reference to FIG. 5. FIG. 5 is a flowchart illustrating operations of the cloud server illustrated in FIG. 3 and FIG. 4. In the cloud server 1, in Step S11, the interface control unit 31 controls an interface including dialogue between the user U and the monitoring robot 2. In Step S12, the device operation setting information acquisition unit 33 acquires the respective device operation setting information 143 of the plurality of controlled devices connectable via the network N. In Step S13, in response to acquisition of information indicating execution of a predetermined function from a predetermined device among the plurality of controlled devices, the influence information notification unit 34 refers to the respective device operation setting information 143 of the predetermined device and related devices and, in a case where execution of the predetermined function is determined to affect the operation setting of another device, notifies the user U to that effect, by dialogue or by interrupting the dialogue, under control of the interface control unit 31 in Step S11.

In operation of the cloud server 1, while the monitoring robot 2 engages in dialogue with the user U, the cloud server 1 acquires the information from the dialogue, and the interface control unit 31 considers operating conditions of devices operating in the home of the user U, and notifies the user U to that effect when execution of a predetermined function of a predetermined device is determined to affect operation settings of another device.

Accordingly, merely by engaging in dialogue with the monitoring robot 2, the user U can know how execution of the predetermined function of the predetermined device affects and propagates to other devices when the plurality of in-home devices execute functions that affect one another.

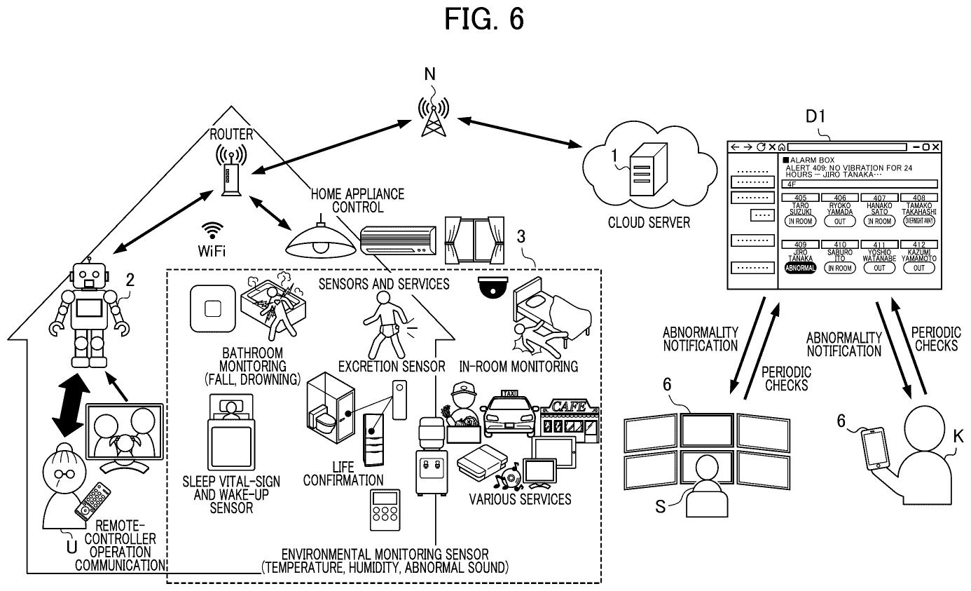

Hereinafter, various embodiments of the Living Robot Care service in the information processing system illustrated in FIG. 1 will be described. First, with reference to FIG. 6, a first embodiment of the Living Robot Care service in the information processing system illustrated in FIG. 1 will be described. FIG. 6 is a diagram illustrating the first embodiment of the Living Robot Care service in the information processing system illustrated in FIG. 1.

The first embodiment of the Living Robot Care service illustrated in FIG. 6 illustrates an overall configuration of the information processing system that realizes the Living Robot Care service.

In the home of the user U, various devices, including sensors and services such as the monitoring robot 2 and the controlled devices 3, are arranged. The controlled devices 3 include home appliances (hereinafter, “home appliances”) such as a toilet, a refrigerator, an electric pot, lighting equipment, an air conditioner, and automatic open/close curtains. The sensors include, for example, sensors for bathroom monitoring (fall and drowning), an excretion sensor, an in-room monitoring camera, a sleep vital and wake-up sensor, and an environmental monitoring sensor (temperature, humidity, abnormal sound, or the like). The respective sensors transmit detected information to the cloud server 1 via the network N. The sleep vitals and wake-up sensor is one device in the sleep monitoring system that realizes a sleep monitoring service. The bathroom monitoring sensor has a function of issuing an alert to the emergency crew in a case where a fall or drowning is detected.

The services include, for example, a sleep monitoring service, a meal delivery service, a flat-rate taxi pickup service, a brain game service, and a music therapy service. In the home of the user U, a wireless router is used as a base station, and the monitoring robot 2 and the controlled devices 3 are connected, via the Internet or another network N, to the cloud server 1 and to the respective external terminals 6 of the service provider S and the family member K.

The monitoring robot 2, during dialogue with the user U, issues verbal prompting to the user U and, in a case where the user U operates the television remote controller, receives a notification of the operation, and transmits the operation information to the cloud server 1.

The cloud server 1 controls the respective devices via the network N, and acquires information from the respective devices. The cloud server 1 acquires the lifestyle information of the user U in advance, and manages the lifestyle information using a dashboard D1 and a scheduler.

In a case where abnormality occurrence information is acquired from the monitoring robot 2 or the controlled devices 3, the cloud server 1 makes a comprehensive determination of the information, including influence of other devices, and, in a case where an abnormality is determined, transmits the information as an abnormality notification to the external terminal 6. Upon receiving an abnormality notification, the external terminal 6 notifies the service provider S and the family member K by issuing the received abnormality notification as an alert (for example, by display or audio). Not only at a time of abnormality detection, but also at preset times or at fixed time intervals, periodic monitoring checks for the user U are performed, and the status of the user U is notified. According to the first embodiment, the various sensors, the home appliances, and the services are connected, whereby a platform can be constructed in which the monitoring robot 2 serves as a UI (user interface). As a result, the comprehensive Living Robot Care service that provides total care for the user U can be provided.

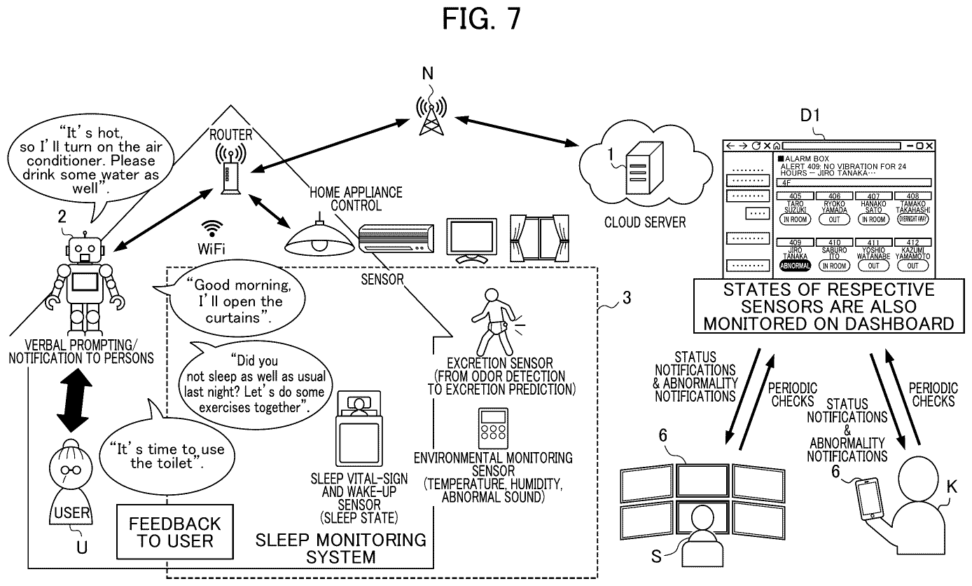

Next, with reference to FIG. 7, a second embodiment of the Living Robot Care service in the information processing system illustrated in FIG. 1 will be described. FIG. 7 is a diagram illustrating the second embodiment of the Living Robot Care service in the information processing system illustrated in FIG. 1. The second embodiment of the Living Robot Care service illustrated in FIG. 7 is an example in which, among components of the information processing system that realizes the Living Robot Care service, states of the respective sensors and home appliances are optimized by prompting of the monitoring robot 2.

In this case, the cloud server 1 causes the monitoring robot 2 to output an audio message based on the lifestyle information, thereby initiating dialogue with the user U.

Specifically, based on the daily lifestyle information of the user U, when a usual toilet time arrives, the monitoring robot 2 outputs an audio message, such as “It's time to go to the toilet”. In a case where the wake-up time of the user U is slightly later than the habitual wake-up time, the monitoring robot 2 outputs an audio message, such as “Did you not sleep as well as usual last night? Let's do some exercises together”. Furthermore, when it is detected that the user U has risen from the bed, the monitoring robot 2 outputs an audio message, such as “Good morning, I'll open the curtains”. When the room temperature exceeds a predetermined temperature, the monitoring robot 2 outputs an audio message, such as “It's hot, so I'll turn on the air conditioner. You should drink some water”.

Since the various types of detection information of the sensors acquired by the cloud server 1 are presented on the dashboard D1, the service provider S, the family member K, or the like, who are the users of the external terminal 6, can constantly monitor the state of the user U and the state of the user U's home.

According to the second embodiment, prompting of the monitoring robot 2 enables dialogue with the user U and deepens interaction with the user U, and the states of the respective sensors and home appliances can be optimized to match the current state of the user U, based on the lifestyle information of the user U. Feedback can be provided directly to the user U. As a result, communication between the monitoring robot 2 and the user U enables creation of conditions optimal for the daily life of the user U.

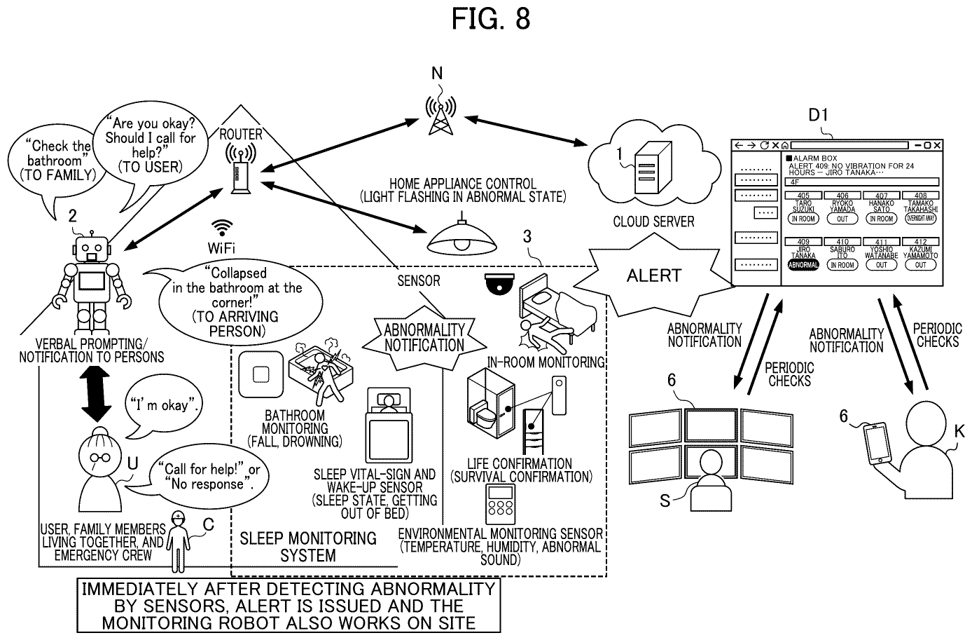

Next, with reference to FIG. 8, a third embodiment of the Living Robot Care service in the information processing system illustrated in FIG. 1 will be described. FIG. 8 is a diagram illustrating the third embodiment of the Living Robot Care service in the information processing system illustrated in FIG. 1. The third embodiment of the Living Robot Care service illustrated in FIG. 8 is an example of the processing operations executed by the monitoring robot 2 in a case where an abnormality in daily life is detected by in-home sensors, in the information processing system that realizes the Living Robot Care service. More specifically, the monitoring robot 2 detects an abnormality in daily life that has occurred to the user U, and reports the abnormality to another party on behalf of the user U.

In the third embodiment, in a case where, for example, the bathroom monitoring sensor detects a fall of a person in the bathroom, an abnormality detection signal is transmitted from the bathroom monitoring sensor to the cloud server 1. Upon receiving an abnormality detection signal, the cloud server 1 controls the monitoring robot 2 to perform verbal prompting to a person and to issue a notification (alert). As verbal prompting to the user U having fallen, the monitoring robot 2 issues an audio message, such as “Are you okay? Should I call for help?”. The monitoring robot 2 is controlled to issue an audio message such as “Check the bathroom” to the family member K, and the lighting equipment is controlled to flash the lights. In addition, when the family member K is not nearby, the cloud server 1 sends a message and an abnormality notification to the external terminal 6 (for example, a smartphone of the family member) and, by causing the external terminal 6 to issue an alert (for example, by displaying the report on the screen or by audio output), informs the family member K and the service provider S of the abnormality of the user U.

In response to the audio message issued by the monitoring robot 2, if the user U replies “I'm okay”, the cloud server 1 refrains from a specific notification by the specific notification unit 35 and the interface control unit 31 controls the monitoring robot 2 to transmit the audio saying “I'm okay” to the external terminal 6 of the family member K. In a case where the user U says “Call for help!” or “Help!”, the cloud server 1 immediately makes emergency reporting to a fire department under control of the interface control unit 31.

In a case where no response is returned despite verbal prompting to the user U, the cloud server 1 refers to, for example, the operation information of the bathroom dryer and the lifestyle information 141, based on the device operation setting information of the plurality of in-home devices, and determines whether the detection information from the bathroom fall sensor constitutes an abnormality. In a case where an abnormality is determined, the cloud server 1 makes emergency reporting to a fire department under control of the interface control unit 31.

In response to the emergency reporting, when a paramedic C is dispatched by the fire department and arrives at the home of the user U, the cloud server 1 identifies the paramedic C based on the spoken statements of the paramedic C and on the images from the eye camera of the monitoring robot 2, and controls the monitoring robot 2 to issue an audio message, such as “Collapsed in the bathroom on the right at the far end of the corridor!”, thereby conveying the position of the user U to the paramedic C.

Thus, according to the third embodiment, immediately after an abnormality is detected by a sensor, an alert is issued and, at the same time, the on-site monitoring robot 2 engages with the user U, the family member K, and the dispatched paramedic C, enabling a smooth and rapid response appropriate to the on-site situation.

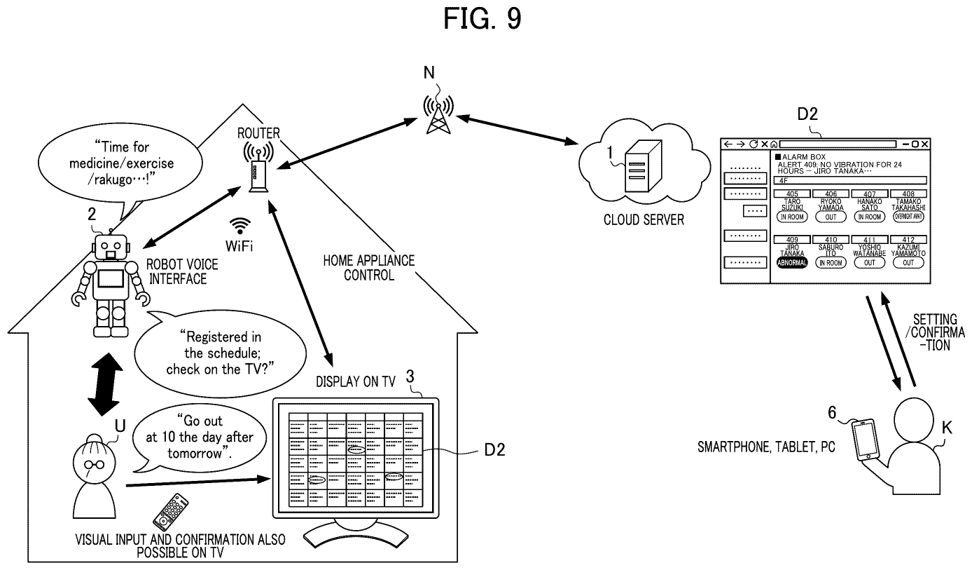

Next, with reference to FIG. 9, a fourth embodiment of the Living Robot Care service in the information processing system illustrated in FIG. 1 will be described. FIG. 9 is a diagram illustrating the fourth embodiment of the Living Robot Care service in the information processing system illustrated in FIG. 1. The fourth embodiment of the Living Robot Care service illustrated in FIG. 9 is an example in which the daily life of the user U is improved through schedule management in the information processing system that realizes the Living Robot Care service.

In this fourth embodiment, the family member K of the user U operates an app screen of the external terminal 6, or the browser of the external terminal 6, to access the cloud server 1 and display a My Page of the user U (for the family member K). By operating a “Schedule Setting/Confirmation” button on the My Page, the interface control unit 31 of the cloud server 1 activates the schedule management function (scheduler) of the cloud server 1 and displays a scheduler screen D2 (schedule management screen).

On the scheduler screen D2, items relating to plans in the lifestyle information 141 of the user U can be set or confirmed, and the family member K can register or change the plans in the schedule, such as the time to take medicine, the time to exercise, and the time to watch television (rakugo). When a schedule of the user U is updated on the scheduler screen D2, the interface control unit 31 of the cloud server 1 controls the monitoring robot 2 to output an audio message to notify the user U of the schedule update.

Plans can also be registered in a schedule through dialogue between the user U or the family member K and the monitoring robot 2 by speaking to the monitoring robot 2, for example, “Go out at 10 the day after tomorrow”. Furthermore, the user U or the family member K can operate a remote controller at hand, display a schedule screen of the controlled device 3 such as a television, and operate the contents of the schedule to register or change the plans in the schedule in the same manner. When registration or change of the schedule is successfully completed, the monitoring robot 2 outputs an audio message, such as “Registered in the schedule. Check on the TV?”, or “Registered the plan to go out at 10 the day after tomorrow!”, allowing the user U to confirm the completion of registration or change of the plan in the schedule. In a case where the user U says “Yes” in response to the question “Check on the TV?” from the monitoring robot 2, the interface control unit 31 of the cloud server 1 causes the scheduler screen D2 to be displayed on the television screen, allowing the user U to confirm the plan registered in the schedule.

When the actual planned time arrives, the interface control unit 31 of the cloud server 1 controls the monitoring robot 2 to notify the user U by outputting an audio message, such as “Time for medicine/exercise/rakugo . . . !”.

According to the fourth embodiment, by dialogue between the family member K or the user U and the monitoring robot 2, the schedule management function (scheduler) of the cloud server 1 enables registration or change (including deletion) of a plan of the user U. A daily schedule of the user U is managed on the cloud server 1, and the monitoring robot 2 can provide information corresponding to the daily schedule to the user U through dialogue in a timely manner.

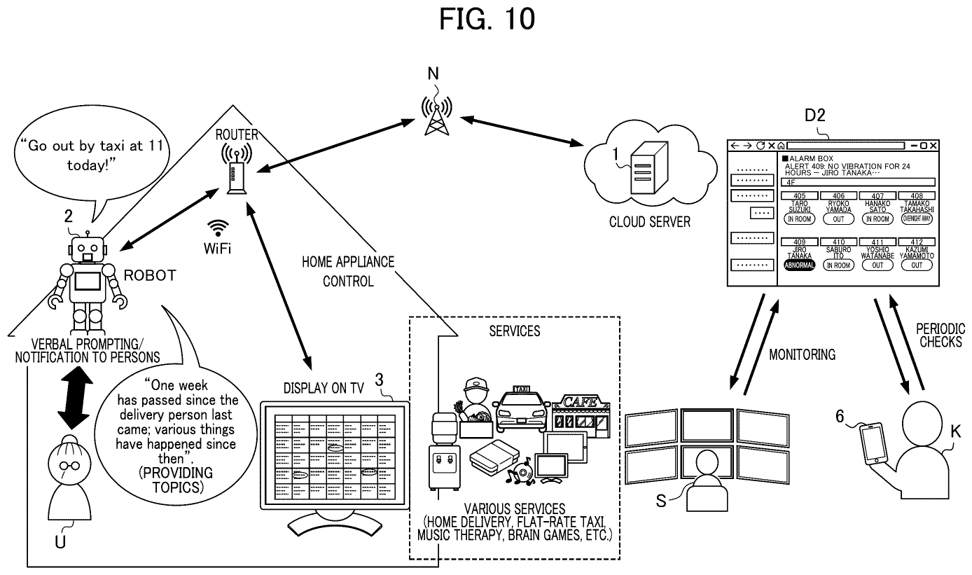

Next, with reference to FIG. 10, a fifth embodiment of the Living Robot Care service in the information processing system illustrated in FIG. 1 will be described. FIG. 10 is a diagram illustrating the fifth embodiment of the Living Robot Care service in the information processing system illustrated in FIG. 1. The fifth embodiment of the Living Robot Care service illustrated in FIG. 10 is an example in which the schedule management function is linked with various services in the information processing system that realizes the Living Robot Care service. More specifically, in this example, the monitoring robot 2 cooperates with the services to notify the user, based on a schedule in which plans for services such as home delivery and transportation are preset.

According to the fifth embodiment, plans such as home delivery, a flat-rate taxi, music therapy, and brain games are preregistered in the scheduler, and before the planned time arrives, for example, at a wake-up time, the monitoring robot 2 outputs an audio message, such as “Go out by taxi at 11 today!”, during dialogue between the user U and the monitoring robot 2. Based on the past information remaining in the scheduler, the monitoring robot 2 can also provide topics, for example, by issuing an audio message such as “One week has passed since the delivery person last came; various things have happened since then”.

According to the fifth embodiment, by linking the schedule management function and various services, during dialogue between the user U and the monitoring robot 2, the monitoring robot 2 issues an audio message to provide topics on scheduled services to be received and contents of services already received by the user U, allowing the user U to always experience new activities or reminisce about past topics.

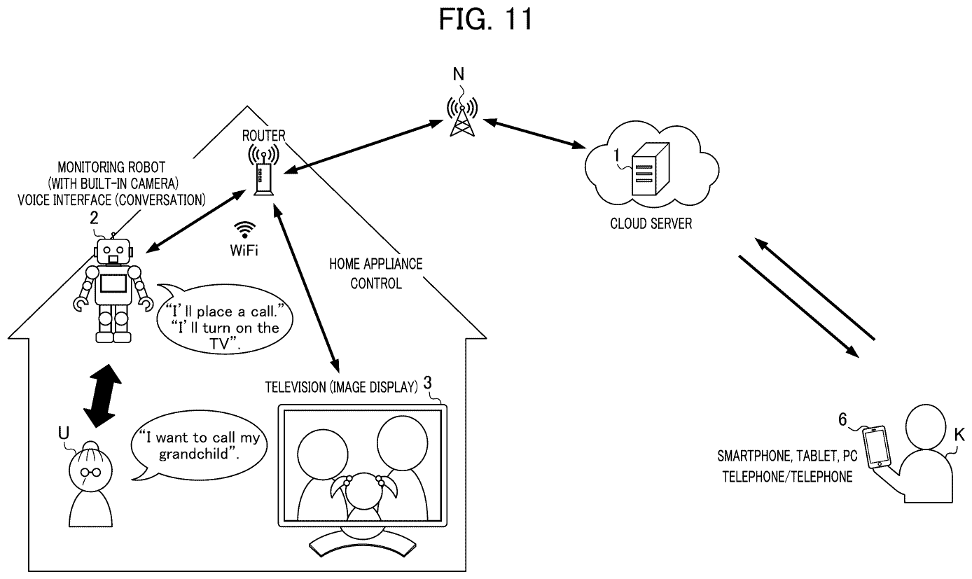

Next, with reference to FIG. 11, a sixth embodiment of the Living Robot Care service in the information processing system illustrated in FIG. 1 will be described. FIG. 11 is a diagram illustrating the sixth embodiment of the Living Robot Care service in the information processing system illustrated in FIG. 1. The sixth embodiment of the Living Robot Care service illustrated in FIG. 11 is a basic example in which the monitoring robot 2 itself serves as a UI (user interface) in the information processing system that realizes the Living Robot Care service. More specifically, in this example, the monitoring robot 2 utilizes controlled devices such as a television connected to the network N, and realizes two-way communication.

In the sixth embodiment, during dialogue between the user U and the monitoring robot 2, in a case where the user U says, for example, “I want to call my grandchild”, the monitoring robot 2 issues an audio message, such as “I'll place a call” or “I'll turn on the TV”. The interface control unit 31 of the cloud server 1 turns on the television and attempts to place a call to an external terminal 6 of a distant family member K using the videophone function. When connection is established with the external terminal 6, an image of the family member K captured by a camera of the external terminal 6 is displayed on the television screen, and a video call starts. Accordingly, merely by engaging in dialogue with the monitoring robot 2, the user U can make a video call to the family member K (a grandchild).

According to the sixth embodiment, the cloud server 1 is preregistered with an association between a predetermined keyword uttered by the user U to the monitoring robot 2 and an operation corresponding to the keyword. When the user U utters the predetermined keyword during dialogue with the monitoring robot 2, the monitoring robot 2 serves as a UI and causes the devices in the home to execute the series of operations desired by the user U on behalf of the user U, thereby enabling the user U to live comfortably.

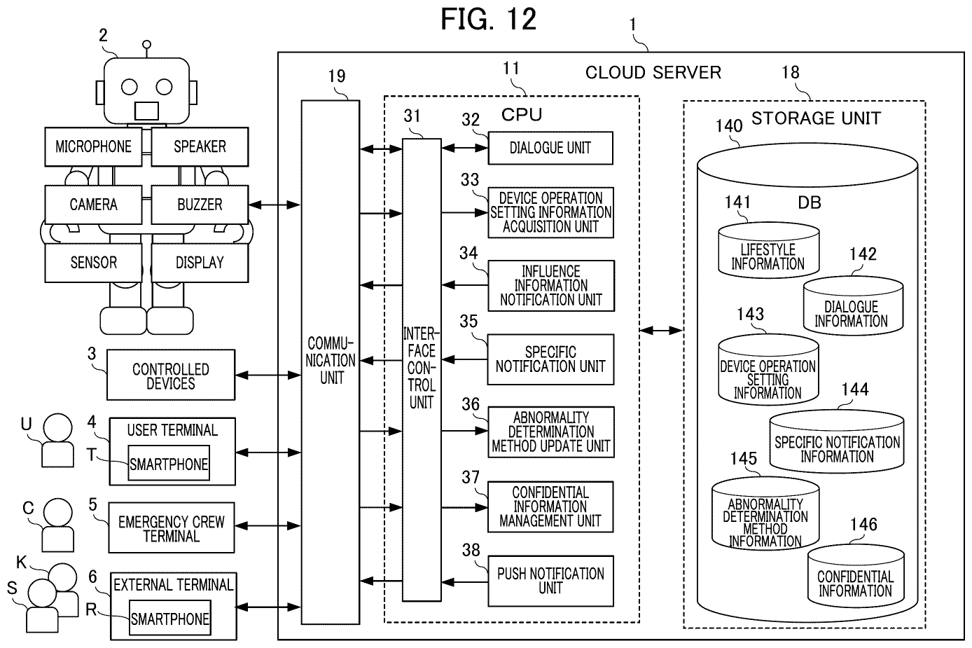

Next, with reference to FIG. 12, a second functional configuration of the cloud server 1 according to one embodiment of the information processing apparatus of the present invention will be described. In describing the second functional configuration, components identical to those in the functional configuration illustrated in FIG. 4 are denoted by the same reference numerals, and descriptions thereof are omitted.

In the second functional configuration, as illustrated in FIG. 12, in the CPU 11 (see FIG. 2 and FIG. 4) of the cloud server 1, when a series of processing related to the Living Robot Care service is executed for the user U, the interface control unit 31 and a push notification unit 38 function.

The interface control unit 31 controls the monitoring robot 2 such that the smartphone T operated by the user U is linked to the dialogue with the user U. Specifically, the monitoring robot 2 serving as a human interface is linked with the smartphone T as coexisting interfaces (two user interfaces). In this arrangement, the monitoring robot 2 primarily issues simple verbal prompting to a person and receives simple voice commands from a person, while the smartphone T or a remote controller primarily performs more complex operations such as schedule input and service use. By linking the smartphone T and the monitoring robot 2 in this manner, the interface can be used in a way that adapts to the usability and circumstances of the user U, enabling the user U to receive care services more comfortably.

The interface control unit 31 starts control of the monitoring robot 2, including dialogue with the user U, when predetermined conditions are satisfied, such as activation of a conversation mode of the monitoring robot 2 by a specific word or by physically touching the monitoring robot 2. Accordingly, the user U can awaken the monitoring robot 2 and engage in conversation at a desired timing.

The push notification unit 38 acquires content for push notification to a predetermined user U when at least some devices among the plurality of devices execute a predetermined function and, under control of the interface control unit 31, notifies the content by dialogue as a push notification to the user U or to an administrator. The administrator includes a person designated by the user U (for example, a family member). Accordingly, verbal prompting to the user U is performed by push notification via the monitoring robot 2.

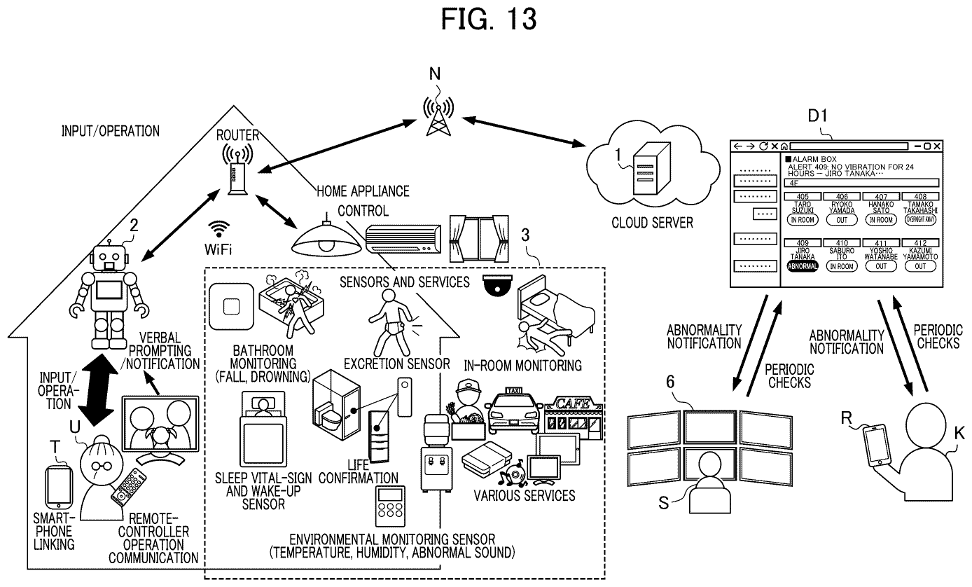

Hereinafter, various embodiments of the Living Robot Care service in the information processing system including a cloud server having the second functional configuration illustrated in FIG. 12 will be described. First, with reference to FIG. 13, a seventh embodiment of the Living Robot Care service in the information processing system illustrated in FIG. 1 will be described. FIG. 13 is a diagram illustrating the seventh embodiment of the Living Robot Care service in the information processing system including the cloud server having the second functional configuration illustrated in FIG. 12.

The seventh embodiment of the Living Robot Care service illustrated in FIG. 13 is a modified example based on the first embodiment of the Living Robot Care service illustrated in FIG. 6.

In the seventh embodiment, as illustrated in FIG. 13, a smartphone T, operated by the user U as a mobile terminal, is provided in the home of the user U. A smartphone application program (hereinafter, “smartphone app”), provided by a provider of the present service, is installed on the smartphone T. Under control of the cloud server 1, the smartphone app provides information to the user U in conjunction with the monitoring robot 2. The smartphone app transmits input information and instructions, generated by the user U's operation of the smartphone app screen, to the cloud server 1.

By linking the monitoring robot 2 with the smartphone T to serve as user interfaces for the user U, the two user interfaces, namely the smartphone T and the monitoring robot 2, can provide care for the user U.

In the information processing system, all operations can be performed by the user U using the smartphone T. However, issuing verbal prompting to the user U and receiving simple voice instructions from the user U are primarily handled by the monitoring robot 2, while complex operations (such as schedule input and service use) are mainly performed through screen operations of the smartphone T or the television (for example, by a graphical user interface (GUI) or by operation of a television remote controller).

Interaction between the user U and the monitoring robot 2 is reflected in real time in the status displayed on the screen of the smartphone T. Voice-based interaction between the user U and the monitoring robot 2 is also displayed on the screen of the smartphone T in chat format, so the user U can monitor the process of the interaction in text.

Even when voice misrecognition occurs on the side of the monitoring robot 2, the user U can confirm, on the screen of the smartphone T, the text recognized by the monitoring robot 2 through voice recognition, so that the user U can identify the cause of success or failure of the voice recognition.

When the user U uses the smartphone T to correct portions of the failed interaction with the monitoring robot 2, correct/incorrect data is accumulated in the cloud server 1. Under control of the cloud server 1, this data is then used to perform machine learning of the conversation AI of the monitoring robot 2, thereby improving the voice recognition accuracy of the monitoring robot 2.

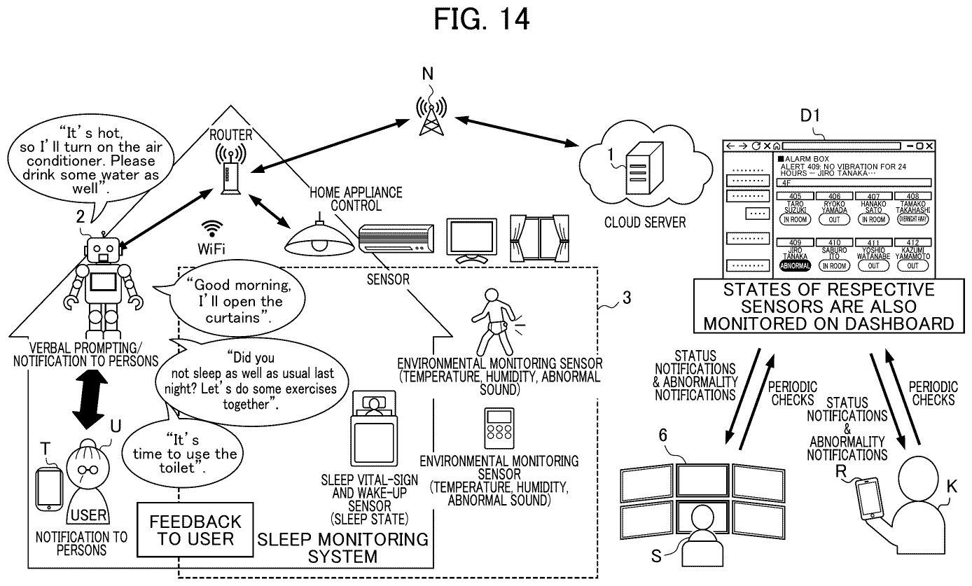

Next, with reference to FIG. 14, an eighth embodiment of the Living Robot Care service in the information processing system illustrated in FIG. 1 will be described. FIG. 14 is a diagram illustrating the eighth embodiment of the Living Robot Care service in the information processing system including the cloud server having the second functional configuration illustrated in FIG. 12.

The eighth embodiment of the Living Robot Care service illustrated in FIG. 14 is a modified example based on the second embodiment of the Living Robot Care service illustrated in FIG. 7.

In the eighth embodiment, a “push verbal prompting mode” and a “conversation mode” are provided in the monitoring robot 2. In the “push verbal prompting mode”, the home appliances and sensors are controlled in conjunction with the monitoring robot 2 issuing a push notification for verbal prompting to the user U. The home appliances and sensors are controlled based on time, environment, and various sensor information (such as sleep vital-sign sensors).

In the eighth embodiment, the control content is not merely a reading of data, such as a result of comparison with past data, but content that has been processed into refined guidance. Specifically, as indicated by the speech balloons in FIG. 14, verbal prompting is performed to provide guidance and advice for the next action of the user U. In this case, interaction between the user U and the monitoring robot 2 does not take place, and no audio is generated. However, the content of the push verbal prompting of the monitoring robot 2 is transmitted from the cloud server 1 to the smartphone T and displayed on the smartphone screen, so the user U can confirm the push verbal prompting content as text on the smartphone screen.

The “conversation mode” is a function that allows the user U to perform a predetermined action to awaken the monitoring robot 2 and enjoy conversation with the monitoring robot 2. Specifically, when the user U says a specific word, for example “Robot-kun”, or physically touches the monitoring robot 2, the cloud server 1 detects this predetermined action and controls the monitoring robot 2 to activate the “conversation mode”.

After the “conversation mode” is activated, a spoken instruction from the user U, such as “Open the curtains”, is recognized by the monitoring robot 2, and the curtains are opened under control of the cloud server 1. At the same time, the monitoring robot 2 responds by issuing an audio message, such as “Good morning, I'll open the curtains”. When the “conversation mode” is activated later than usual, the monitoring robot 2 provides push verbal prompting to the user U by issuing an audio message, such as “Did you not sleep as well as usual last night?” or “Let's do some exercises together”, and continues the conversation with the user U.

In addition, when the room temperature detected by a temperature sensor installed in the room is higher than usual, the monitoring robot 2 provides verbal prompting to the user U by issuing an audio message, such as “It's hot, so I'll turn on the air conditioner. Please drink some water as well”. The air conditioner is operated under control of the cloud server 1.

When a predetermined time has elapsed since the user U last used the toilet, or when a scheduled time is reached, the monitoring robot 2 provides verbal prompting to the user U by issuing an audio message, such as “It's time to use the toilet”. The above sequence of interactions is reflected on a chat screen displayed on the smartphone T when the “conversation mode” is activated. As a result, when the user U utters “Open the curtains”, the monitoring robot 2 activates the “conversation mode”. The user U can then confirm, in text displayed on the chat screen of the smartphone T, the content of the conversation with the monitoring robot 2 and the operating states of household appliances in the room. On the dashboard D1 as well, an administrator or the like can monitor the conversation content of the user U and the operating states of household appliances in the room, in addition to monitoring the states of the respective sensors.

According to the eighth embodiment, in the “push verbal prompting mode”, the monitoring robot 2 provides verbal prompting to the user U and confirms the state of the user U based on the user U's responses, while also optimizing the states of the respective sensors and household appliances in the room to match the preferences of the user U. According to the eighth embodiment, by providing the “conversation mode”, the user U can utter a specific word to awaken the monitoring robot 2 and engage in conversation. When the user U activates the “conversation mode”, the monitoring robot 2 determines that the user desires conversation, and provides verbal prompting to the user U by issuing an audio message, such as “Did you not sleep as well as usual last night?” or “Let's do some exercises together”. Accordingly, the user U can enjoy conversation with the monitoring robot 2 whenever the user U wants to talk.

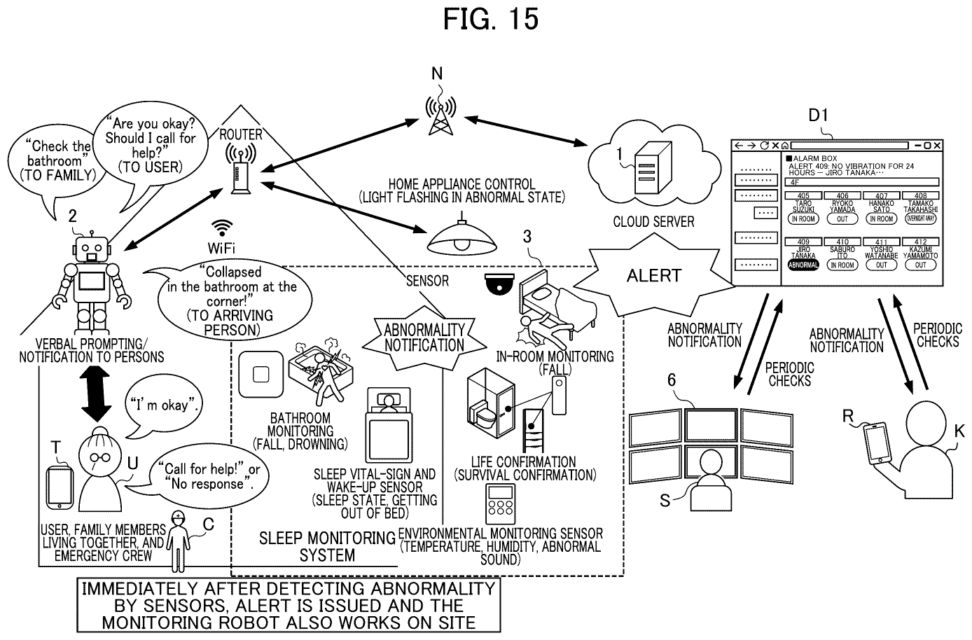

Next, with reference to FIG. 15, a ninth embodiment of the Living Robot Care service in the information processing system illustrated in FIG. 1 will be described. FIG. 15 is a diagram illustrating the ninth embodiment of the Living Robot Care service in the information processing system including the cloud server having the second functional configuration illustrated in FIG. 12.

The ninth embodiment of the Living Robot Care service illustrated in FIG. 15 is a modified example based on the third embodiment of the Living Robot Care service illustrated in FIG. 8.

In the ninth embodiment, a smartphone T is provided in addition to the monitoring robot 2 serving as an interface for the user U. When the monitoring robot 2 detects an abnormality in daily life, the detection result is notified to the smartphone T and displayed on an app screen. In addition, based on the detected abnormality, an alert is issued to the user U through the built-in alert functions of the smartphone T, such as a warning sound, a warning light, or vibration.

The monitoring robot 2 also alerts the user to the abnormality using a warning sound and movement. The monitoring robot 2 moves to the area where the abnormality has been detected, provides verbal prompting, captures images with its camera, and establishes external communication by a video call or the like. Specifically, the monitoring robot 2 uses autonomous navigation with a camera and LiDAR to move to the location of a sensor that has detected an abnormality, or to the source of an abnormal sound such as a scream, a thud from a fall, or the sound of breaking glass, and uploads site information, such as audio and images acquired at the site, to the cloud server 1. When it is confirmed that a sensor has malfunctioned or that there is no problem with the user U, the abnormality detection operation is terminated at that point. On the other hand, when an abnormal state occurs, the monitoring robot 2 notifies at least one among family members, a service operating company, and a security company, and monitors the state until a person comes to the site. Since the monitoring robot 2 transmits, via the cloud server 1, its location information and behavior history to the smartphone T, the user U can always check the position and behavior of the monitoring robot 2 on an app screen of the smartphone T.

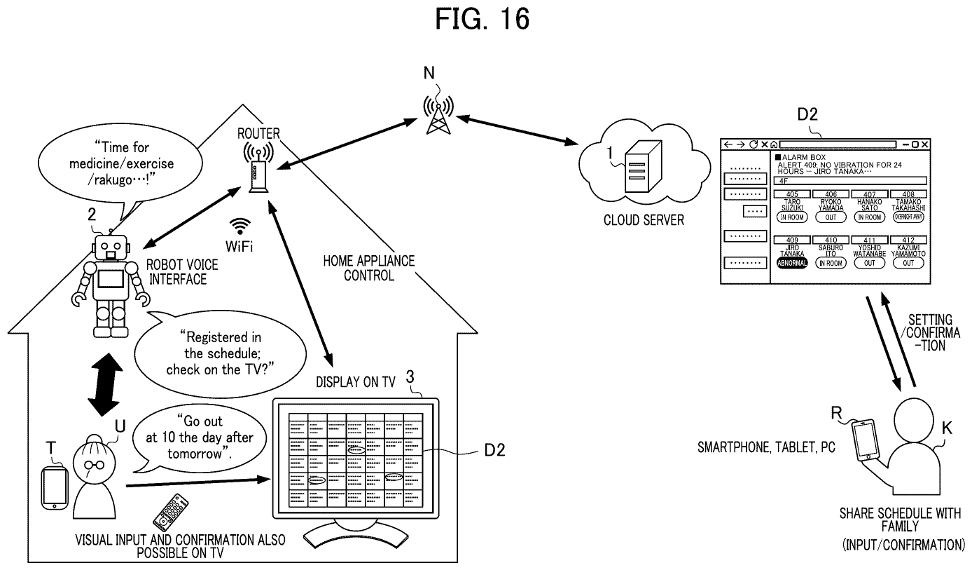

Next, with reference to FIG. 16, a tenth embodiment of the Living Robot Care service in the information processing system illustrated in FIG. 1 will be described. FIG. 16 is a diagram illustrating the tenth embodiment of the Living Robot Care service in the information processing system including the cloud server having the second functional configuration illustrated in FIG. 12.

The tenth embodiment of the Living Robot Care service illustrated in FIG. 16 is a modified example based on the fourth embodiment of the Living Robot Care service illustrated in FIG. 9.

In the tenth embodiment, a smartphone T is provided in addition to the monitoring robot 2 serving as an interface for the user U, and, using the schedule management function of the cloud server 1, the schedule of the user U is managed via the app screen of the smartphone T and the screen of the family smartphone R.

Under the schedule management function, the daily schedule of the user U is managed on the app screen of the smartphone T. The monitoring robot 2 and the smartphone T notify the user U at the start and end times of plans set in the schedule, thereby enabling the user U to go about daily life in line with the set plans.

In addition to manual input to the smartphone T, input methods for a schedule or the like include the television, the family smartphone R, or conversation with the monitoring robot 2. Input methods include, for example, voice input and manual input using a touch portion or a switch portion of the robot. When it is difficult for the user U to perform input operations on the smartphone, the monitoring robot 2 turns on the television and guides the user U through television-based input.

Since the schedule is uploaded to the cloud server 1, the cloud server 1 transmits the schedule to a family smartphone R or the like, thereby allowing the user U to share the schedule with a family member (for input and confirmation). As described above, according to the tenth embodiment, by managing the schedule of the user U with the monitoring robot 2 and the smartphone T, the user U's daily life can be improved.

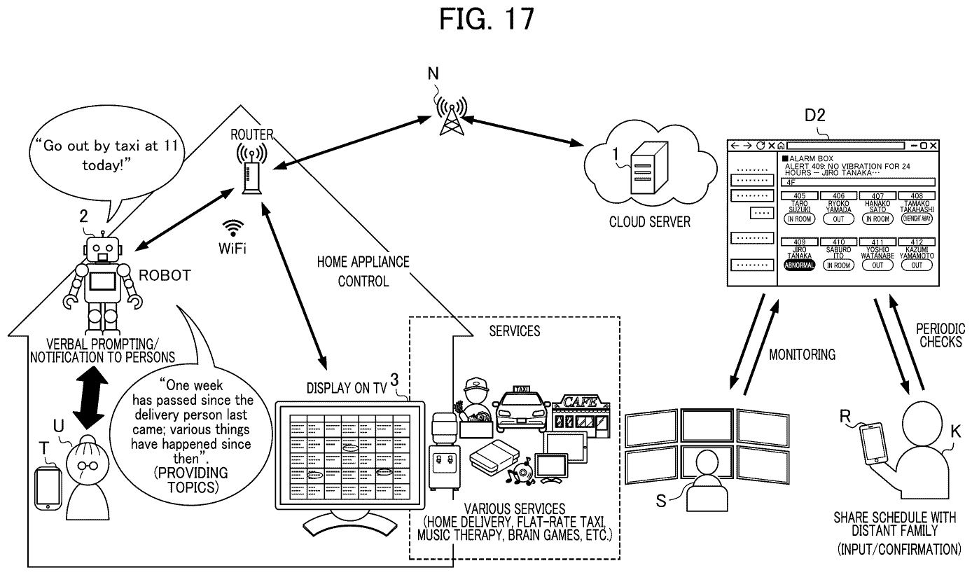

Next, with reference to FIG. 17, an eleventh embodiment of the Living Robot Care service in the information processing system illustrated in FIG. 1 will be described. FIG. 17 is a diagram illustrating the eleventh embodiment of the Living Robot Care service in the information processing system including the cloud server having the second functional configuration illustrated in FIG. 12.

The eleventh embodiment of the Living Robot Care service illustrated in FIG. 17 is a modified example based on the fifth embodiment of the Living Robot Care service illustrated in FIG. 10.

In addition to the schedule management function, the eleventh embodiment includes a linking function configured to interlink the schedule with various services. Under the linking function, calendar events and push reminder notifications from the monitoring robot 2 are transmitted to the smartphone T via the cloud server 1, and the respective status information is displayed on an app screen of the smartphone T, so the user U can confirm the plans from the status information displayed on the app screen of the smartphone T. In addition to the smartphone T, by transmitting the plans to, for example, the television or a family smartphone R, the user U can also check the plans on the television. Furthermore, a family member can check the plans of the user U for the day on the screen of a family smartphone.

As described above, according to the eleventh embodiment, by providing the linking function configured to link the schedule and various services, the schedule of the user U can be shared between the user U and family members.

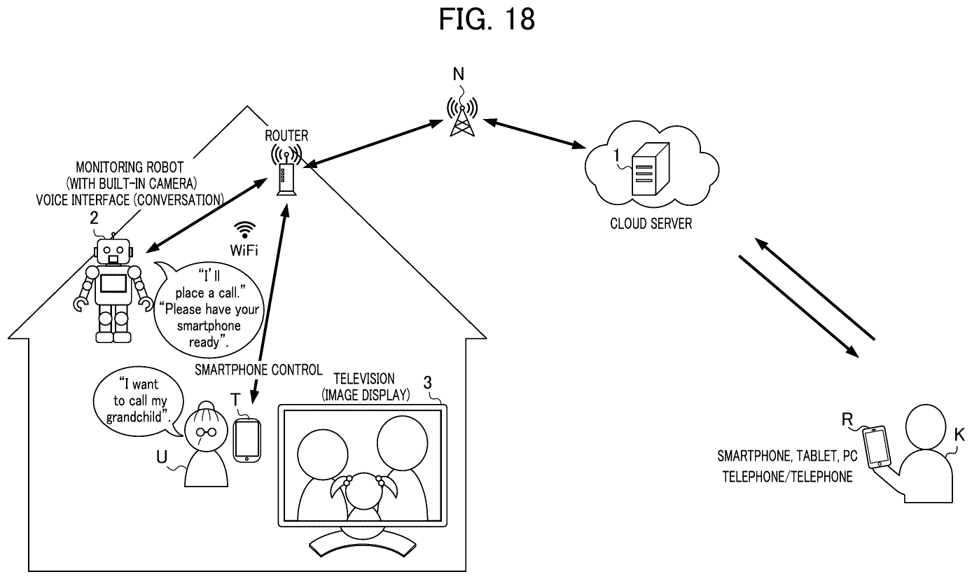

Next, with reference to FIG. 18, a twelfth embodiment of the Living Robot Care service in the information processing system illustrated in FIG. 1 will be described. FIG. 18 is a diagram illustrating the twelfth embodiment of the Living Robot Care service in the information processing system including the cloud server having the second functional configuration illustrated in FIG. 12.

The twelfth embodiment of the Living Robot Care service illustrated in FIG. 18 is a modified example based on the sixth embodiment of the Living Robot Care service illustrated in FIG. 11.

The twelfth embodiment is a basic configuration example in which the monitoring robot 2 and the smartphone T respectively serve as UIs for the user U. In this case, as illustrated in FIG. 18, for example, when the user U says to the monitoring robot 2, “I want to call my grandchild”, the monitoring robot 2 responds to the user U by issuing an audio message, such as “I'll place a call. Please have your smartphone ready”. At the same time, an instruction to place a call is sent to the cloud server 1, and the cloud server 1 then controls the smartphone T to place an outbound call to the preregistered family smartphone R, so that a voice call or a video call is placed from the smartphone T of the user U to the family smartphone R. Accordingly, the current appearance and condition of the user U, as well as the surrounding situation, are displayed on the family smartphone R. In addition to a telephone call between the smartphone T of the user U and the family smartphone R, it is also possible to use a tablet or PC for a web meeting by using Internet telephony and SNS.

As described above, according to the twelfth embodiment, since the monitoring robot 2 and the smartphone T respectively serve as UIs for the user U, when the user U says to the monitoring robot 2, “I want to call my family”, the smartphone T places a call to the family smartphone R without the user U directly operating the smartphone T. Thus, even a user U who has difficulty operating the smartphone T can readily make a telephone call to a family member.

Although one embodiment of the present invention has been described above, the present invention is not limited to the above embodiment, and modifications and improvements within a range capable of achieving an object of the present invention are included in the present invention.

For example, the hardware configuration illustrated in FIG. 2 is merely an example for achieving an object of the present invention, and is not particularly limiting.

The functional block diagram illustrated in FIG. 4 is merely an example, and is not particularly limiting. In other words, it is sufficient that the information processing apparatus is provided with functions capable of executing the above-described series of processing as a whole, and the functional blocks and databases used to realize the functions are not limited to the example illustrated in FIG. 4.

Locations of the functional blocks and the databases are not limited to FIG. 4, and may be selected arbitrarily. Each functional block and each database may be implemented solely by hardware, solely by software, or by a combination of hardware and software.

When the processing of each functional block and each database is executed by software, a program constituting the software is installed on a computer from a network or a recording medium. The computer may be embedded in dedicated hardware. The computer may also be, for example, a cloud server, a general-purpose smartphone, or a personal computer, capable of executing various functions by installing programs.

A recording medium including such a program may be implemented not only by removable media distributed separately from the main unit of the apparatus in order to provide the program to each user, but also by a recording medium provided to each user with the program preinstalled in the apparatus main unit.

In the present specification, steps describing a program to be recorded on a recording medium include not only processing performed chronologically in the described order, but also processing executed in parallel or individually, without necessarily being executed in chronological order.

In this specification, the term “system” indicates an overall apparatus composed of a plurality of devices and means. In the above embodiments, as examples of other users (parties) in relation to the user U (a specific user), a family member, such as a child or a grandchild, and a service provider S, such as a service operating company or staff thereof, were exemplified, but the invention is not limited thereto.

In summary, it is sufficient that the information processing apparatus to which the present invention is applied is configured as follows, and may be implemented in various embodiments. Specifically, the information processing apparatus to which the present invention is applied (for example, the cloud server 1 illustrated in FIG. 4) includes:
an interface control unit (for example, the interface control unit 31 illustrated in FIG. 4) configured to control an interface including dialogue with a predetermined user (for example, the user U illustrated in FIG. 4);
a device operation setting information acquisition unit (for example, the device operation setting information acquisition unit 33 illustrated in FIG. 4) configured to acquire respective device operation setting information of a plurality of devices connectable via a communication network (for example, the network N illustrated in FIG. 1), such as a bathroom fall sensor, an odor sensor, a fire alarm, a television, a video recorder, an air conditioner, a refrigerator, a washing machine, a bathroom dryer, or an electric pot (including settings such as detection settings and sensitivity settings of the bathroom fall sensor, sensitivity settings of the odor sensor, detection settings and sensitivity settings of the fire alarm, operation settings of the television, recording settings of the video recorder, operation and temperature settings of the air conditioner, operation and temperature settings of the refrigerator, operation settings of the washing machine, operation settings of the bathroom dryer, and operation settings of the electric pot); and
an influence information notification unit (for example, the influence information notification unit 34 illustrated in FIG. 4) configured to, in response to acquisition of information indicating execution of a predetermined function (for example, an emergency reporting) from a predetermined device (for example, the bathroom fall sensor) among the plurality of devices, refer to the device operation setting information and, when execution of the predetermined function is determined to affect an operation setting of another device (for example, when operation of a bathroom dryer is determined to cause malfunction of the bathroom fall sensor), to notify the user (for example, the user U illustrated in FIG. 4, another family member K, or a service provider S) to that effect (for example, that operation of the bathroom dryer may be causing malfunction of the bathroom fall sensor) by dialogue or by interrupting the dialogue under control of the interface control unit. Accordingly, the user can know, merely by engaging in dialogue, that a plurality of devices (for example, a bathroom dryer, a bathroom fall sensor, or an emergency reporting function) are executing functions that affect one another.

In the above information processing apparatus (for example, the cloud server 1 illustrated in FIG. 4), the device operation setting information acquisition unit (for example, the device operation setting information acquisition unit 33 illustrated in FIG. 4) acquires the operation setting information of the device, based on dialogue with the predetermined user (for example, the user U illustrated in FIG. 4) that is conducted under control of the interface control unit (for example, the interface control unit 31 illustrated in FIG. 4). Accordingly, the user can perform operation settings of the device merely by engaging in dialogue.

In the above information processing apparatus (for example, the cloud server 1 illustrated in FIG. 4), the influence information notification unit (for example, the influence information notification unit 34 illustrated in FIG. 4) performs notification, based on dialogue with the predetermined user (for example, the user U illustrated in FIG. 4) that is conducted under control of the interface control unit (for example, the interface control unit 31 illustrated in FIG. 4). Accordingly, the user (for example, the user U illustrated in FIG. 4) can know, merely by engaging in dialogue with the monitoring robot 2, that execution of a predetermined function (for example, a drying function) of a predetermined device (for example, a bathroom dryer) affects operation (for example, fall detection or emergency reporting) of another device (for example, a bathroom fall sensor).

In the above information processing apparatus (for example, the cloud server 1 illustrated in FIG. 4), the interface control unit (for example, the interface control unit 31 illustrated in FIG. 4) executes control of output to confirm with the predetermined user (for example, the user U illustrated in FIG. 4) that a specific device (for example, a bathroom fall sensor) among the plurality of devices is to perform a specific notification (for example, a notification to the fire department). Specifically, for example, when a notification of a bathroom fall is to be made to the fire department, the interface control unit can confirm the notification with the user U.

In the above information processing apparatus (for example, the cloud server 1 illustrated in FIG. 4), a specific notification unit (for example, the specific notification unit 35 illustrated in FIG. 4) is provided. The specific notification unit is configured to, when an abnormality determination is made based on the device operation setting information of the plurality of devices (for example, by also referring to operation information of a bathroom dryer to determine whether detection information of a bathroom fall sensor is abnormal), make the specific notification (for example, an emergency reporting to the fire department) under control of the interface control unit (for example, the interface control unit 31 illustrated in FIG. 4). Accordingly, the accuracy of the specific notification can be improved based on the device operation setting information of the plurality of devices.

In the above information processing apparatus (for example, the cloud server 1 illustrated in FIG. 4), the specific notification unit (for example, the specific notification unit 35 illustrated in FIG. 4), under control of the interface control unit (for example, the interface control unit 31 illustrated in FIG. 4), further outputs information relating to the abnormality determination to a responder who responds to the specific notification (for example, a paramedic dispatched from a fire station in response to an emergency reporting).

Accordingly, for example, information regarding where the predetermined user (for example, the user U illustrated in FIG. 4) has fallen can be provided to the emergency crew that has arrived.

In the above information processing apparatus (for example, the cloud server 1 illustrated in FIG. 4), an abnormality determination method update unit (for example, the abnormality determination method update unit 36 illustrated in FIG. 4) is configured to update a method of abnormality determination (for example, determination logic or a determination procedure) used by the specific notification unit (for example, the specific notification unit 35 illustrated in FIG. 4), based on necessity information of the specific notification acquired under control of the interface control unit (for example, the interface control unit 31 illustrated in FIG. 4) with respect to a determination result of abnormality determination. Accordingly, for example, when a device is determined to be abnormal and the specific notification is about to be made, if dialogue with the user reveals that the specific notification is unnecessary, the subsequent abnormality determination method can be revised.

In the above information processing apparatus (for example, the cloud server 1 illustrated in FIG. 4), the interface control unit (for example, the interface control unit 31 illustrated in FIG. 4) acquires lifestyle information of the predetermined user (for example, the user U illustrated in FIG. 4) based on dialogue with the predetermined user, and the specific notification unit (for example, the specific notification unit 35 illustrated in FIG. 4) makes abnormality determination based on the lifestyle information. Accordingly, the user can have his/her lifestyle information managed (for example, managing the time at which the user U habitually takes a bath) merely by engaging in dialogue, and the accuracy of the specific notification can be improved. For example, when the bathroom fall sensor detects a fall at a time when the user is not bathing, and the bathroom dryer is operating, the detection can be determined to be false, caused by noise of the bathroom dryer. Such a notification can thereby be prevented.

In the above information processing apparatus (for example, the cloud server 1 illustrated in FIG. 4), the interface control unit (for example, the interface control unit 31 illustrated in FIG. 4) performs predetermined input/output processing when the predetermined user (for example, the user U illustrated in FIG. 4) engages in dialogue with another user having a specific relationship with the predetermined user (for example, a child or grandchild of an elderly user U, a staff member of a service operating company providing a monitoring service, or a delivery staff member). The predetermined input/output processing includes, for example, automatically activating the eye camera of the monitoring robot 2 to capture the elderly user U and distributing the captured image to a terminal of the other user such as the external terminal 6 illustrated in FIG. 4, or causing the monitoring robot 2 to issue an audio message to the user U regarding events that occurred after the previous monitoring visit. Accordingly, the convenience of dialogue with another user can be enhanced and topics can be provided, thereby improving the user's emotional state.

In the above information processing apparatus (for example, the cloud server 1 illustrated in FIG. 4), a specific information management unit (for example, the confidential information management unit 37 illustrated in FIG. 4) is further provided, the specific information management unit being configured to, in response to acquisition of predetermined information (for example, secret information) designated with a specific management attribute (for example, a secret conversation only between the user U and the monitoring robot 2) from the predetermined user (for example, the user U illustrated in FIG. 4) under control of the interface control unit (for example, the interface control unit 31 illustrated in FIG. 4), manage the predetermined information (for example, the secret conversation) based on the specific management attribute. As secret conversation information, for example, soliloquy, diary, or emotions of the user U at that time are not output (and cannot be accessed) to anyone other than the user U, and are stored in a storage means such as non-volatile memory that cannot be deleted even by the user U. Accordingly, for example, through exchange of secret information confessed only to the monitoring robot 2 by the user U, attachment to the monitoring robot can be fostered.

The interface control unit (for example, the interface control unit 31 illustrated in FIG. 12) can control the interface (for example, the robot 2 illustrated in FIG. 12) so as to link a mobile terminal (for example, the smartphone T illustrated in FIG. 12) operated by the predetermined user (for example, the user U illustrated in FIG. 12) with dialogue with the predetermined user.

A push notification unit (for example, the push notification unit 38 illustrated in FIG. 12) can further be provided, the push notification unit being configured to acquire content to be provided as a push notification to the predetermined user when at least some of the plurality of devices execute a predetermined function, and, under control of the interface control unit, to provide the content through the dialogue as a push notification to the predetermined user or to an administrator of the predetermined user.

The interface control unit (for example, the interface control unit 31 illustrated in FIG. 12) can initiate control of the interface (for example, the robot 2 illustrated in FIG. 12), including dialogue with the predetermined user (for example, the user U illustrated in FIG. 12), in response to a trigger of a preset condition (for example, uttering a specific word or physically touching the robot 2 to activate the conversation mode of the robot 2) is satisfied.

An information processing method executed by the above information processing apparatus (for example, the cloud server 1 illustrated in FIG. 4) includes:
an interface control step (for example, Step S11 illustrated in FIG. 5) of controlling an interface including dialogue with a predetermined user (for example, the user U illustrated in FIG. 4);
a device operation setting information acquisition step (for example, Step S12 illustrated in FIG. 5) of acquiring respective device operation setting information of a plurality of devices connectable via a communication network; and
an influence information notification step (for example, Step S13 illustrated in FIG. 5) of referring to the device operation setting information in response to acquisition of information indicating execution of a predetermined function from a predetermined device among the plurality of devices, and, when execution of the predetermined function is determined to affect an operation setting of another device, notifying a user to that effect by the dialogue or by interrupting the dialogue under control of the interface control step. Accordingly, the user can know, merely by engaging in dialogue, that a plurality of devices (for example, a bathroom dryer, a bathroom fall sensor, or an emergency reporting function) are executing functions that affect one another.

In the computer (for example, the CPU 11 of the cloud server 1 illustrated in FIG. 4), control processing is executed, the control processing including:
an interface control step (for example, Step S11 illustrated in FIG. 5) of controlling an interface including dialogue with a predetermined user (for example, the user U illustrated in FIG. 4);
a device operation setting information acquisition step (for example, Step S12 illustrated in FIG. 5) of acquiring respective device operation setting information of a plurality of devices (for example, a bathroom dryer, a bathroom fall sensor, an emergency reporting function, or the like) connectable via a communication network; and
an influence information notification step (for example, Step S13 illustrated in FIG. 5) of, in response to acquisition of information indicating execution of a predetermined function from a predetermined device among the plurality of devices, referring to the device operation setting information and, when execution of the predetermined function is determined to affect an operation setting of another device, notifying a user to that effect by the dialogue or by interrupting the dialogue under control of the interface control step. Accordingly, the user can know, merely by engaging in dialogue, that a plurality of devices (for example, a bathroom dryer, a bathroom fall sensor, or an emergency reporting function) are executing functions that affect one another.

### EXPLANATION OF REFERENCE NUMERALS

1: cloud server
2: monitoring robot
3: controlled device
4: user terminal (for example, smartphone or remote controller)
5: emergency crew terminal
6: external terminal (for example, smartphone)
31: interface control unit
32: dialogue unit
33: device operation setting information acquisition unit
34: influence information notification unit
35: specific notification unit
36: abnormality determination method update unit
37: confidential information management unit
38: push notification unit
K: family member (child, grandchild, or the like)
N: network
S: service provider (service operating company or the like)
U: user

1. An information processing apparatus, comprising:
an interface control unit configured to control an interface including dialogue with a predetermined user;
a device operation setting information acquisition unit configured to acquire respective device operation setting information of a plurality of devices connectable via a communication network; and
an influence information notification unit configured to, in response to acquisition information indicating execution of a predetermined function from a predetermined device among the plurality of devices, refer to the device operation setting information and, when execution of the predetermined function is determined to affect an operation setting of another device, notify the user to that effect, under control of the interface control unit, by dialogue or by interrupting the dialogue.

2. The information processing apparatus according to claim 1, wherein the device operation setting information acquisition unit acquires device operation setting information based on dialogue with the predetermined user conducted under control of the interface control unit.

3. The information processing apparatus according to claim 1, wherein the influence information notification unit notifies based on dialogue with the predetermined user conducted under control of the interface control unit.

4. The information processing apparatus according to claim 1, wherein the interface control unit controls an output to confirm with the predetermined user that a specific device among the plurality of devices is about to make a specific notification.

5. The information processing apparatus according to claim 4, further comprising a specific notification unit configured to, when an abnormality determination is made based on the device operation setting information of the plurality of devices, make the specific notification under control of the interface control unit.

6. The information processing apparatus according to claim 5, wherein the specific notification unit outputs, under control of the interface control unit, information relating to the abnormality determination to a responder who responds to the specific notification.

7. The information processing apparatus according to claim 5, further comprising an abnormality determination method update unit configured to update a method of the abnormality determination by the specific notification unit, based on information on necessity of the specific notification acquired under control of the interface control unit with respect to a result of the abnormality determination.

8. The information processing apparatus according to claim 1, wherein the interface control unit acquires lifestyle information of the predetermined user based on dialogue with the predetermined user, and the specific notification unit makes the abnormality determination, based on the lifestyle information.

9. The information processing apparatus according to claim 1, wherein the interface control unit performs predetermined input/output processing when the predetermined user engages in dialogue with another user having a specific relationship with the predetermined user.

10. The information processing apparatus according to claim 1, further comprising a specific information management unit configured to, in response to acquisition of predetermined information designated with a specific management attribute from the predetermined user under control of the interface control unit, manage the predetermined information based on the specific management attribute.

11. The information processing apparatus according to claim 1, wherein the interface control unit controls the interface to link a mobile terminal operated by the predetermined user with dialogue with the predetermined user.

12. The information processing apparatus according to claim 1, further comprising a push notification unit configured to acquire content for push notification to the predetermined user when at least some of the plurality of devices execute a predetermined function, and to provide the content through the dialogue as a push notification to the predetermined user or to an administrator of the predetermined user, under control of the interface control unit.

13. The information processing apparatus according to claim 1, wherein the interface control unit initiates control of the interface, including the dialogue with the predetermined user, in response to a trigger of a preset condition being satisfied.

14. An information processing method executed by an information processing apparatus, the method comprising:
an interface control step of controlling an interface including dialogue with a predetermined user;
a device operation setting information acquisition step of acquiring respective device operation setting information of a plurality of devices connectable via a communication network; and
an influence information notification step of, under control of the interface control step, in response to acquisition of information indicating execution of a predetermined function from a predetermined device among the plurality of devices, referring to the device operation setting information and, when execution of the predetermined function is determined to affect an operation setting of another device, notifying the user to that effect by dialogue or by interrupting the dialogue.

15. A non-transitory computer readable medium storing a program for causing a computer to execute control processing comprising:
an interface control step of controlling an interface including dialogue with a predetermined user;
a device operation setting information acquisition step of acquiring respective device operation setting information of a plurality of devices connectable via a communication network; and
an influence information notification step of, in response to acquisition of information indicating execution of a predetermined function from a predetermined device among the plurality of devices, referring to the device operation setting information and, when execution of the predetermined function is determined to affect an operation setting of another device, notifying the user to that effect by dialogue or by interrupting the dialogue under control of the interface control step.
